(19) United States
(12) Patent Application Publication
(10) Pub. No.: US 2009/0031999 A1
(43) Pub. Date: Feb. 5, 2009

(54) Charge air chiller

(76) Inventor: Donald Charles Erickson, Annapolis, MD (US)

Correspondence Address: Donald C. Erickson;Energy Concepts Co LLC, 627 Ridgely Avenue, Annapolis, MD, 21401, US

(21) Appl. No.: 12/218,570

(22) Filed: Jul. 16, 2008

Related U.S. Application Data
(60) Provisional application No. 60/963,111, filed on Aug. 2, 2007.

(51) Int. Cl. F02B 29/04; F25B 27/02; F25B 7/00

(52) U.S. Cl. 123/563; 62/238.3; 62/79

(57) ABSTRACT

A system for chilling the pressurized charge air to a reciprocating engine is disclosed wherein the chilling is provided by a thermally activated refrigeration cycle powered by waste heat from the engine system. This reduces the required compression power, and also retards knock, making higher compression ratios possible. The chilling system is designed to minimize the amount of chilling required, and also to enable use of compression heat to power the chiller. The disclosed improvement also accommodates exhaust gas recirculation, plus providing activation heat from the exhaust gas, plus Miller cycle timing of the intake valves. Referring to FIG. 1, the charge air from turbocharger 5 is cooled in three stages: heat recovery stage 10; ambient-cooled stage 11; and chilling stage 12. Condensed moisture is removed from the charge air by valve 14 before the charge is supplied to inlet manifold 2.

### CROSS REFERENCE TO RELATED APPLICATIONS

NA

### STATEMENT REGARDING FEDERALLY SPONSORED RESEARCH OR DEVELOPMENT

NA

### BACKGROUND OF THE INVENTION

An intercooler system for an internal combustion engine is designed to provide subambient temperature charge air without mechanical refrigeration, and preferably without the complications of powering the refrigeration system with exhaust combustion gas heat.

The advantage of chilling engine inlet air, whether from the atmosphere or from a turbocharger/supercharger, are well documented in the prior art. Compression energy varies approximately with the absolute temperature, and less energy to compression means more useful energy out, e.g. higher efficiency. With a turbocharger/supercharger and conventional intercooler, the charge air is well above ambient temperature. The prior art discloses many ways of chilling the inlet or charge air to below ambient temperature. Most involve mechanical power input of one sort or another. For example, prior art examples of chilling charge air with mechanical refrigeration are found in U.S. Pat. Nos. 6,347,618; 6,748,934; 4,683,725; 6,796,134; and application publications 20040020477 and 20060081225. Related disclosures show the chilling derived from mechanically compressed air: US Patent application publications 20070006585 and 20070125346. All of these disclosed approaches have the problem that a significant portion of the power/efficiency gain from lower temperature compression is consumed in producing the refrigeration. Other disclosures of chilling the charge air or inlet air make use of incidentally available refrigeration, e.g. from LNG fuel, or the evaporation of ethanol fuel, or from snow.

The compression energy saved due to chilling inlet air to the turbocharger has no energy cost other than the refrigeration, and the energy cost of the refrigeration is very low when it is produced from waste heat. On the other hand, when engine charge air is chilled, the compression savings are offset by the temperature reduction of the compressed gas, which means more fuel must be supplied to achieve the desired high temperature. However the marginal efficiency of the power gain divided by the increased fuel (to make up the temperature deficit) is substantially higher than the baseline efficiency of the engine, so there is a net energy benefit from charge air chilling also.

Many types of thermally activated refrigeration cycles are disclosed in the prior art. Examples include absorption cycles, adsorption cycles with solid sorbents, Rankine—reverse Rankine cycles, jet ejector cycles, Stirling—reverse Stirling cycles, and others. The prior art discloses applying engine system waste heat of one form or another to many of those cycles so as to produce chilling for the inlet air or charge air. The absorption cycles commonly use the working fluids LiBr —H₂0 or ammonia-water (NH₃—H₂0), although various organic working pairs are also known. They can have mechanical solution pumps, thermally activated pumps (e.g. as disclosed in U.S. Pat. No. 4,270,365), or percolator pumps (e.g. GB Publication 2432205 dated May 16, 2007). The latter type normally includes an inert gas such as H₂ or He, to equalize the pressures throughout the apparatus, together with the NH₃—H₂0 working pair. Other prior art examples of using engine system reject heat to power a thermally activated refrigeration cycle in order to chill either charge air or inlet air are found in U.S. Pat. Nos. 6,880,344 and 4,270,365.

Whereas any of the above thermally activated cycles and others can be applied in the presently disclosed application, the preferred thermally activated cycle is the ammonia-water absorption cycle, using a mechanical solution pump. Prior art examples of this are found in U.S. Pat. Nos. 2,548,408; 4,890,463; and 6,739,119. This working pair cycle can be implemented with exceptionally compact, economical, and efficient heat exchangers. When a cycle with this working pair incorporates the improvements of U.S. Pat. Nos. 6,679,083, 6,715,290, and the present disclosure (for example, direct heating of the aqua from the charge air heat and/or the jacket heat), it can be powered by exceptionally low temperature heat.

U.S. Pat. No. 6,321,552 discloses using engine exhaust heat to power an absorption chiller or a steam/water ejector chiller and then using the chilling to chill either inlet air or charge air. The charge air is first cooled by ambient-cooled fluid, and then by the chiller. U.S. Pat. No. 2,548,408 discloses chilling the inlet air of an internal combustion engine with an ammonia-water absorption refrigeration cycle which is powered by a heat transfer fluid which is heated by both engine jacket heat and exhaust heat.

Exhaust gas recirculation (EGR) is one effictive means of reducing NOx emissions from internal combustion engines. By substituting exhaust for part of the charge air, the excess oxygen is reduced, which chemically reduces NOx. Also, the final exhaust flow to atmosphere is reduced, so a given concentration of NOx equates to less total emission. Many methods of recirculating part of the exhaust are described in the prior art, e.g. U.S. Pat. Nos. 6,244,256; 6,978,772; and 7,178,492. There are however several disadvantages with EGR. First, the exhaust becomes very corrosive when it reaches condensing conditions. When it is kept above condensing temperature, the temperature of the charge mixture (charge air plus recirculated exhaust) increases, thus increasing the compression work and limiting the charge density. Conversely, cooling the exhaust below condensing temperature requires costly metallurgy to withstand the corrosive environment in the recirculation path. Even then, the exhaust is at best cooled to only about 55° C., i.e. well above ambient temperature, and hence the compression energy increases. Hence, EGR as presently practiced always entails some decrease in efficiency and power. The recirculated exhaust can be taken from either before or after the turbocharger. When taken before, (“pressurized” EGR), it is possible to avoid any compression requirement for the recirculated exhaust, for example as disclosed in U.S. Pat. No. 7,267,117.

Among the problems encountered in the above-described prior art are the following. Too much chilling is required to reduce the charge air temperature to below ambient temperature, which in turn requires too much driving heat; the required temperature of the driving heat is so high that only exhaust combustion gas heat meets the requirement; use of exhaust combustion gas heat requires a costly bypass damper; there is no provision for removal of condensed water from the charge air intercooler pressure containment; too much ambient cooling is required; the thermally activated equipment is extremely large and costly; the charge air chiller is too large and causes too much pressure drop; and not enough of the high quality engine reject heat is left for other purposes, such as production of additional power. Beyond the above, there is the problem that the actually realized efficiency gains from prior art charge air chilling embodiments have been quite small, and usually not worth the complications of providing the chilling.

What is needed is apparatus and method for chilling charge air which: accomplishes the chilling in compact, low pressure drop (on charge air side) equipment, which requires a minimum amount of driving heat, preferably from a normally unused source such as the charge air itself, and/or from another low temperature source such as jacket water; requiring a minimum amount of ambient cooling; and having provision for removal of the water condensate from the pressure containment. Most of all, what is needed is to actually achieve some efficiency and power increase benefit from charge air chilling worth more than the additional apparatus necessary to provide the chilling.

### BRIEF SUMMARY OF THE INVENTION

The above and other useful objectives are achieved via apparatus and process for chilling internal combustion charge air comprising cooling the charge air to near-ambient temperature, then chilling it to below ambient, and using engine waste heat to power the chiller. The preferred source of at least part of the waste heat is from the heat of compression from the turbocharger, in which case there will be a third (hot end) heat exchanger for the charge air. The preferred type of waste-heat powered chiller is an ammonia water absorption cycle with a mechanical solution pump. In order to achieve maximum increase in energy efficiency, the above improvement is preferably combined with one or more additional measures, including an increase in boost pressure and/or compression ratio, and chilling the turbocharger inlet air.

### BRIEF DESCRIPTION OF THE SEVERAL VIEWS OF THE DRAWING

FIG. 1 is one preferred embodiment of the turbocharged, intercooled and interchilled internal combustion engine system.

FIG. 2 is one preferred embodiment of supplying cooling and chilling to the improved interchiller.

FIG. 3 is another preferred embodiment of the intercooled and interchilled engine system.

FIG. 4 is one preferred embodiment of the intercooled/interchilled engine system that incorporates exhaust gas recirculation, and the recirculated gas is also chilled.

FIG. 5 is another preferred embodiment incorporating chilled exhaust recirculation.

FIG. 6 is a preferred embodiment of combining the interchilling plus inlet air chilling systems with pressurized exhaust gas recirculation, wherein only a small pressure ratio compressor (or in some cases no compressor) is required for the exhaust gas, and wherein the heat in the recirculated exhaust provides at least part of the thermal activation to the chiller.

### DETAILED DESCRIPTION OF THE INVENTION

The disclosed charge air chilling system is applicable to any type of positive displacement internal combustion engine, whether pistons reciprocating in cylinders, or rotary type, or other. The disclosed system is applicable to all types of internal combustion cycles which have air chargers, including Diesel—compression ignition; Otto—spark ignition; Miller—delayed (or early) closing of air intake valve; and HCCI. For many of these cycles, further improvements will be made possible owing to the presence of reliable charge air chilling: the engine can be modified to higher compression ratio, and/or higher boost pressure, yielding even higher fuel efficiency, and/or other modifications for further reduction in emissions.

The charge air compressor can be either an exhaust gas powered turbocharger or a mechanically powered supercharger (or both). In typical operation on a 30° C. day, the air is compressed to about 2.5 to 5 bar absolute and about 140° C. to 190° C. A conventional intercooler would then cool it to about 50° C. With the disclosed improvement, the charge air is cooled below 30° C., and preferably down to about 5 to 10° C. This amount of chilling, by about 45° C., will reduce the compression work by over 15%, and reduce the engine fuel consumption by about 3 to 5%. When the chilling improvement is also accompanied by increased compression ratio, an additional efficiency gain of 3 to 5% will also be achieved. These measures also increase the power output of the engine. In order to minimize the amount of chilling necessary to achieve the sub-ambient charge air temperatures, some precooling is accomplished in other section(s) of the charge air cooler. This may include recovery of useful heat in the hottest section, thus cooling the charge air to typically 100° C., and/or also the conventional ambient cooling. The ambient cooling fluid can be air, cooling tower water, ground water, river, lake or ocean water, etc. The ambient-cooled section of the intercooler would preferably cool the charge air to within about 110° C. of ambient temperature—somewhat higher for air-cooling and somewhat lower for water-cooling.

It is preferred to mount all sections of the intercooler (including the chilling section) in one or at most two pressure containment(s), rated for charge air pressure. The several sections are sequentially located in the charge air flowpath. Usually (at most ambient conditions) a substantial amount of water will condense from the air in the chilling section of the intercooler. Even more water will condense out when some recirculated exhaust gas is mixed with the air, due to the high water vapor content of exhaust. Therefore, that section of the intercooler should be arranged such that the condensate will separate from the charge air (mixture). There should be provision to remove this condensed water from the charge air so it does not enter the engine cylinders, for example in liquid slugs, which could cause damage. Also, the water removal system should be designed so as to not allow escape of pressurized charge air. One preferred system for water removal is the combination of a liquid level sensor plus sensor actuated valve. Examples are a mechanically actuated float valve; a float switch and solenoid valve; and a capacitance level sensor plus electric actuated valve. This recovered water is of good purity, and can be used in water injection systems.

Note that in the case wherein exhaust gas recirculation is present, the term “charge air” encompasses the mixture of inlet air plus recirculated gas.

The charge air chilling is accomplished by a thermally activated refrigeration cycle which is powered by reject heat from the internal combustion engine system. The driving heat to power the thermally activated cycle should be at least about 90° C. There are three reject heat streams satisfying that temperature requirement: cylinder jacket coolant, exhaust heat, and charge air compression heat. When EGR is present, it is another preferred source of heat for the thermal activation. The exhaust heat is more than what is necessary to thermally activate the charge air chilling system. On the other hand, the compression heat is nearly the required amount. The compression heat is also a heat stream that is infrequently used for heat recovery. When it is so used, it reduces the amount of ambient cooling required in the intercooler system. Thus the charge air compression heat is one preferred source for the thermally activated chilling cycle. In some circumstances the compression heat will be supplemented with jacket heat. When there is no other use for jacket heat, the jacket heat may sometimes be selected as the only source of activation heat to the thermally activated cycle. The same applies to the exhaust heat. Note that there are three advantages of using charge air compression heat in lieu of exhaust heat. First, the higher pressure of charge air results in its not being as negatively affected by a given pressure drop in the heat exchanger. Secondly, the charge air is cold enough that no bypass damper is required for circumstances when the engine is running whereas the thermally activated system is not running. Third, there is no concern over the corrosion that may occur when a fluid that is below the acid dewpoint temperature of the exhaust is being heated by the exhaust.

This disclosure contemplates chilling the charge air by approximately 20 to 50 degrees Kelvin. After the compression stroke, the compressed charge air will be cooler by about triple that amount. That amount of cooling can have competing effects. For a spark-ignited engine, it will suppress knock, allowing higher compression ratio plus its attendant higher fuel efficiency. However for the diesel engine and SI engine in low load or cold startup conditions, the colder temperature can result in misfiring. Increasing the compression ratio will solve that problem, and increase engine efficiency. However when charge air chilling is retrofitted on an existing engine, the desired amount of increase in compression ratio may exceed the allowable cylinder pressure. In that case the boost pressure would have to be reduced, to allow the compression ratio to be increased the desired amount. The compression ratio can beneficially be increased by about 5% to 35%. The increase can be accomplished by installing taller pistons, or by lengthening the stroke (requires new crankshaft).

When the valve timing is such that the compression ratio is the same as the expansion ratio, it is hypothesized that the cylinder pressure at the end of expansion will be appreciably higher than the pressure at start of compression. That is because of the heat addition at the top of the stroke. On the other hand, the high exhaust temperature coupled with an efficient turbocharger means that the pressure drop ratio on the exhaust side need not be as large as the pressure rise ratio on the air side. In other words, extra pressure energy is available at the end of the expansion stroke, which is more than what is required to power the turbocharger. Failure to use that pressure availability (for example by dissipating it through a waste gate) results in waste and inefficiency. The Miller cycle is one means of reducing or eliminating this waste—early (or late) closure of the intake valve(s) reduces the compression ratio, while not changing the expansion ratio. Miller timing for better utilization of exhaust pressure is predicted to be of benefit coupled with charge air chilling, comparable to its benefit for conventional charge temperatures. It is noted that extreme Miller timing will also effectively reduce the charge air temperature, and allow higher compression ratios. However it severely restricts the charge density, so higher boost pressures are needed, and the open cycle (gas pumping) work increases. The charge air chilling system here disclosed avoids those problems, and allows much less severe Miller timing.

### EXAMPLE 1

A spark-ignited natural gas fueled engine originally has 45° C. charge air, 3.6 bar boost pressure, and compression ratio of 12. The disclosed charge air chiller system is added, providing 10° C. charge air, compression ratio is increased to 15, and boost pressure is decreased to 3.2 bars absolute. Engine efficiency increases by about 6% at full load ISO conditions, and more at warmer ambients.

### EXAMPLE 2

A compression-ignited liquid fueled engine originally has 50° C. charge air, 3.6 bar boost pressure, and compression ratio of 16. After retrofitting a charge air chiller system which provides 15° C. charge air, the compression ratio is increased to 17, and the boost pressure is increased to 3.8 bars absolute.

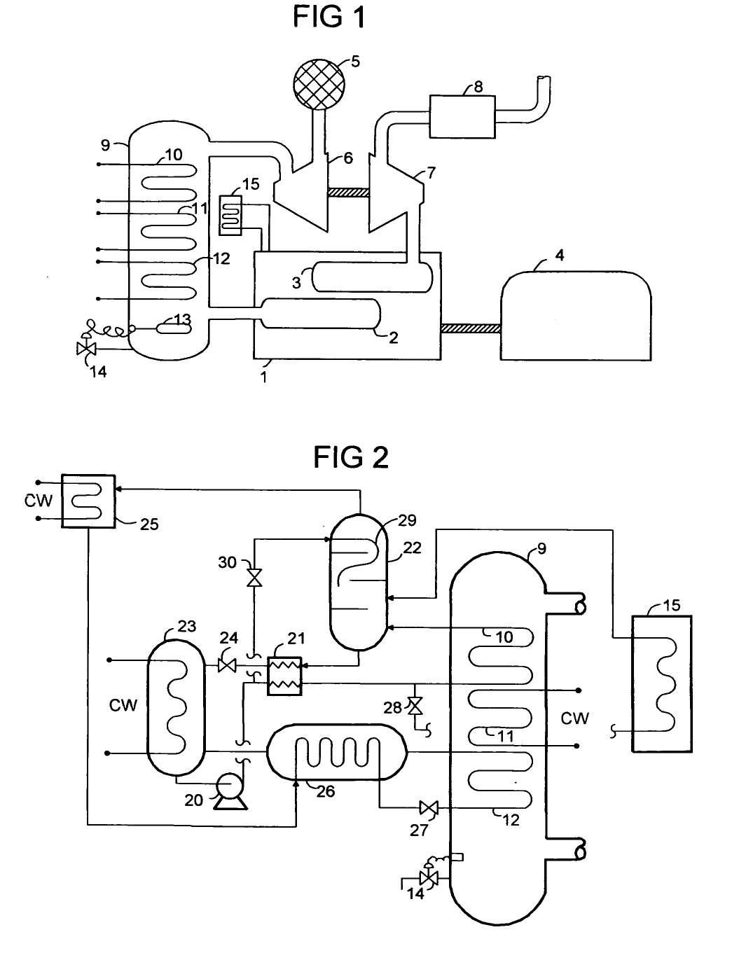

Referring to FIG. 1, internal combustion engine 1 is comprised of inlet manifold 2, exhaust manifold 3, and the powered apparatus 4, which can variously be an electrical generator, a gas compressor, a transmission, a propeller, or other power-absorbing means. Inlet air from filter 5 is supplied to charge compressor 6, which is powered for example by exhaust powered turbine 7. Exhaust treatment apparatus 8 accomplishes any required modifications of the exhaust stream, such as emissions reduction, heat recovery, and silencing. The charge air is supplied to an intercooler system comprised of pressure containment 9 plus three heat exchange segments which are arranged sequentially in the charge air flowpath. Hot end segment 10 is adapted for useful heat recovery. Middle segment 11 is adapted for cooling from an ambient-cooled fluid, and cools the charge air to close to ambient temperature. Cold end segment 12 is supplied with refrigerating fluid, and chills the charge air to below ambient temperature. The moisture which condenses from the chilled charge air drains by gravity to the bottom portion of containment 9, and is controllably removed from the containment by drain valve 14, so as to not let pressurized air escape. When necessary, a mist eliminator would also be provided, to minimize the amount of droplets carried into the inlet manifold. Level sensing mechanism 13, e.g. a float, controls the drain valve, via either electric or mechanical linkage. The chilled charge air is then supplied to inlet manifold 2. The portions of the charge air flowpath that are below ambient temperature and in contact with ambient air are preferably insulated to prevent condensation of moisture on their external surfaces. The internal combustion engine is also adapted to reject cylinder jacket heat through heat exchanger 15.

FIG. 2 relates to the schematic flowsheet of FIG. 1 in that it illustrates the preferred combination of heat transfer fluids which are supplied to the three intercooler segments. Solution pump 20 supplies aqueous ammonia solution via solution heat exchanger (SHX) 21 to heat recovery segment 10, wherein it is partially boiled. The two-phase mixture is routed to rectifier 22, wherein the overhead ammonia vapor is purified to at least about 97% purity. The rectifier bottom liquid is returned through SHX 21 to absorber 23, via pressure letdown valve 24. The overhead vapor from rectifier 22 is condensed to liquid in condenser 25, subcooled in refrigerant heat exchanger (RHX) 26, and supplied to chilling segment 12 (a direct expansion evaporator) via expansion valve 27. The vapor from evaporator 12 is warmed in RHX 26 and then absorbed in absorber 23. Three of the heat exchangers are cooled by ambient-cooled fluid, for example cooling water: condenser 25, absorber 23, and intercooler heat exchange segment 11.

When additional chilling is desired beyond that which the heat available in segment 10 can produce, the optional circuit controlled by valve 28 routes part of the aqueous ammonia solution to another source of heat, for example cylinder jacket heat exchanger 15. Other absorption cycle efficiency-enhancing measures are also contemplated, for example the solution-cooled rectifier 29 supplied by rectifier column feed valve 30.

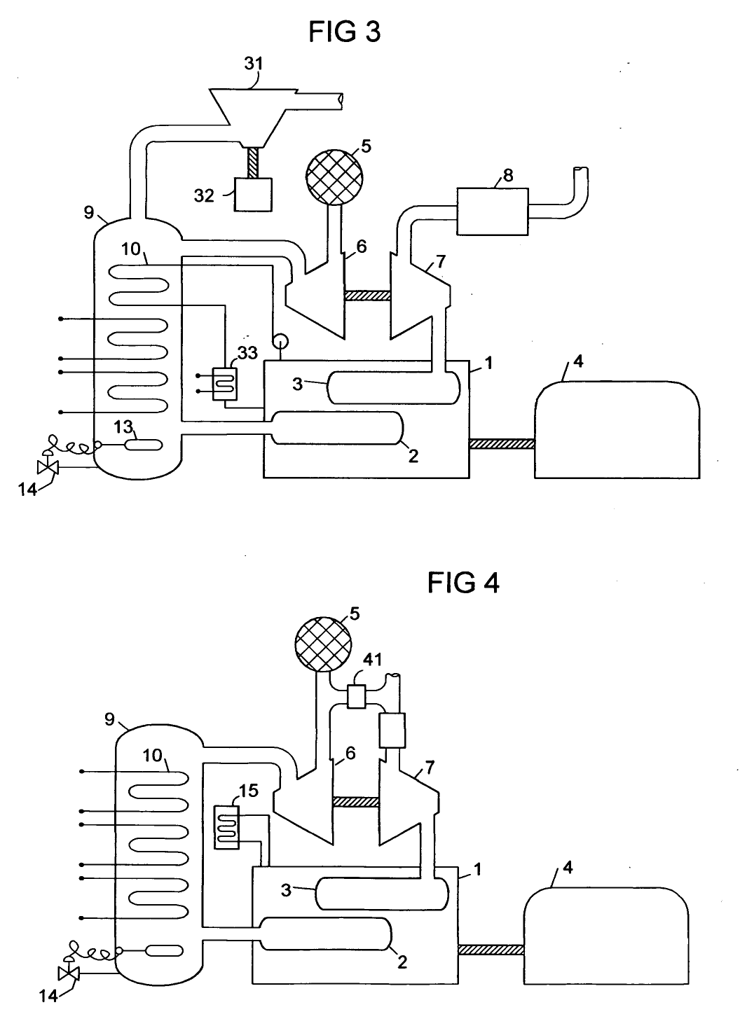

FIG. 3 illustrates other preferred embodiments. For example, a second charge compressor 31 may be supplied. It can compress either additional air, or exhaust mixture. It can be powered by exhaust or by other motive power 32. It is also possible to use jacket coolant to collect useful heat from the charge air, and then have a single heat exchanger 33 deliver the combined heat to the thermally activated chiller and/or to other useful purpose.

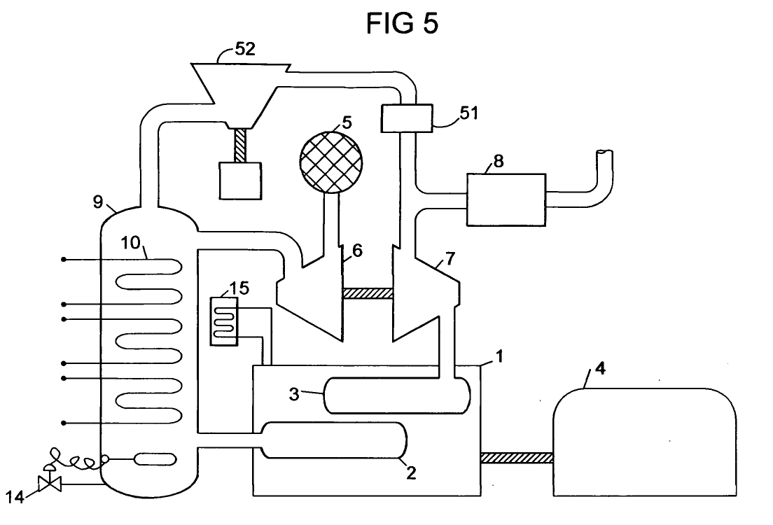

FIG. 4 illustrates one preferred embodiment of the improved intercooler in an engine system incorporating exhaust gas recirculation. The exhaust is first treated in component 42 to remove particulates and optionally recover some heat, and then heat exchanger 41 further cools part of the exhaust gas before it is injected into the air stream supplied to the charge compressor.

FIG. 5 illustrates another EGR embodiment wherein part of the exhaust is cooled in heat exchanger 51, compressed in compressor 52, and then mixed with charge air in the intercooler.

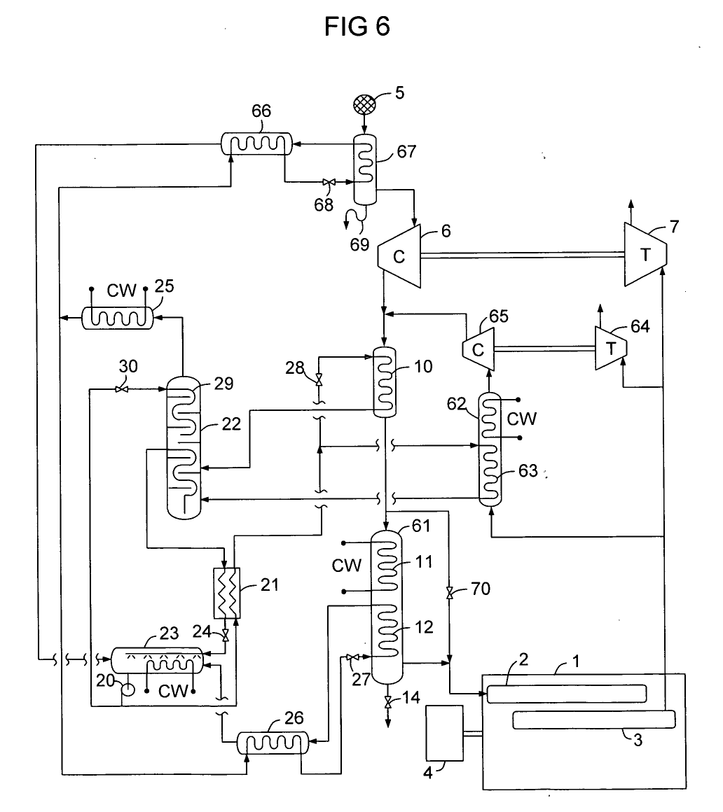

FIG. 6 illustrates a preferred embodiment utilizing pressurized exhaust gas recirculation. The pressurized exhaust is first cooled in containment 62, containing thermal activation heat exchanger 63 plus optionally an ambient cooled fluid heat exchanger. Then it is compressed to the charge air pressure in compressor 65, powered by exhaust powered turbine 64. The exhaust is combined with the charge air and then cooled by the previously disclosed charge air chilling system. For convenience, the two sections 11 and 12 of the chilling system wherein moisture is normally condensed are housed in their own containment 61. Also a charge air bypass valve 70 is provided when needed. This flowsheet also depicts inlet air chilling in addition to charge air chilling—liquid refrigerant from condenser 25 is cooled in RHX 66, expanded at valve 68, and then chills the inlet air in coil 67. Any moisture condensed from the inlet air is removed through liquid trap 69.

The engine is preferably modified and tuned to achieve maximum efficiency and minimum NOx with the disclosed charge air chilling system at design conditions, for example by increasing the compression ratio, using lean burn, and implementing Miller timing. There may still be a tendency to misfire at low load or cold startup conditions, especially with compression ignition. In order to counteract that, a “thermal gate” can be provided—charge air bypass valve 70. By controllably bypassing some of the charge air around the chilling section, the charge air temperature can be temporarily controllably increased so as to prevent misfire.

At the preferred maximum efficiency conditions, the charge air pressure entering manifold 2 will be about 50 to 150 kPa higher in pressure than the exhaust pressure out of manifold 3, in other words just enough to power the turbochargers, as controlled by the selected Miller cycle valve timing. For example, with the inlet pressure at 300 kPa absolute, the exhaust manifold pressure would be about 240 kPa. Note however that the cycle can be simplified so as to eliminate the second turbocharger 64-65, by elevating the exhaust pressure to above the charge air pressure, with some efficiency penalty.

1. An apparatus for chilling the charge air to an internal combustion engine comprised of a charge air compressor, an intercooler which cools the air from said compressor, and an internal combustion engine which further compresses said intercooled air, wherein said intercooler is comprised of at least three sections:
a. a first high temperature section, in which useful temperature heat is recovered from said charge air;
b. a second ambient-cooled section, wherein heat is rejected from said charge air to a cooling fluid; and
c. a third sub-ambient temperature chilling section, wherein refrigeration from a refrigeration system is used to chill the charge air to below ambient temperature.

2. The apparatus according to claim 1, additionally comprised of an ammonia-water absorption system which is powered by reject heat from said engine system and which supplies chilling to said sub-ambient section of said intercooler, and additionally comprised of a water separation and removal system for controllably removing the water which condenses in said intercooler.

3. The apparatus according to claim 2, wherein said water removal system is comprised of
a. a water level sensor; and
b. a valve which is actuated by said sensor.

4. The apparatus according to claim 2, wherein said thermally activated ammonia-water absorption refrigeration system is heated by cylinder jacket coolant from said engine.

5. The apparatus according to claim 2, wherein said absorption refrigeration system is heated by said first high temperature section of said intercooler.

6. The apparatus according to claim 2, wherein said absorption refrigeration system is heated by both charge air heat and by jacket coolant, in separate heat exchangers.

7. The apparatus according to claim 1, wherein the three sections of said intercooler are housed in at most two pressure containments.

8. The apparatus according to claim 1, wherein at least two charge air compressors supply charge air to said intercooler.

9. The apparatus according to claim 1, additionally comprised of an exhaust gas recirculator which supplies part of the exhaust gas from said internal combustion engine to said intercooler.

10. The apparatus according to claim 5, wherein aqueous ammonia from said ammonia absorption refrigeration system is directly heated in said high temperature section of said intercooler, and ammonia refrigerant from said ammonia absorption refrigeration system is directly supplied to said sub-ambient section.

11. The apparatus according to claim 2, additionally comprised of a chilling coil for the inlet air to said charge compressor, and wherein a thermally activated ammonia absorption refrigeration system also supplies refrigeration to said inlet air chilling coil.

12. An intercooled internal combustion engine apparatus comprised of:
a. A charge air compressor;
b. An intercooler comprised of at least two sections which is positioned in the charge air path between said compressor and said engine;
c. A thermally activated ammonia absorption chiller which supplies chilling to one section of said intercooler, and
d. A system for controllably removing the condensation water from said chilled charge air, said system comprised of a water level sensor and a valve actuated by said sensor.

13. The apparatus according to claim 12 additionally comprised of a means for supplying heat to said absorption chiller which is in thermal heat exchange with at least one of engine exhaust and engine cylinder jacket coolant.

14. The apparatus according to claim 12 wherein one section of said intercooler supplies high temperature heat from said charge air to said absorption chiller.

15. The apparatus according to claim 12 additionally comprised of an ambient-cooled section of said intercooler interposed between said two sections, plus a controllable charge air bypass valve which bypasses at least said chilling section.

16. A method for providing chilled charge air to an internal combustion engine comprising:
a. Compressing inlet air
b. Partially cooling the compressed air by transferring heat to a thermally activated refrigeration system
c. Chilling the partially cooled air to below ambient temperature using chilling from said refrigeration system;
d. Removing condensed water from said charge air; and
e. Supplying said chilled charge air to said internal combustion engine.

17. The method according to claim 16 additionally comprising: providing additional cooling to said compressed air between said partial cooling step and said chilling step by exchanging heat with an ambient-cooled cooling fluid.

18. The method according to claim 17 additionally comprising recirculating part of the exhaust gas from said internal combustion engine and combining it with at least one of the inlet air and the air from said compressing step.

19. The method according to claim 17 additionally comprising providing a water cooled ammonia absorption refrigeration system as said thermally activated refrigeration system.

20. The method according to claim 17 additionally comprising providing an air-cooled ammonia absorption refrigeration system as said thermally activated refrigeration system.

21. The method according to claim 16 additionally comprising increasing the compression ratio of the engine, and using Miller cycle timing of the intake valves.

22. An apparatus for chilling charge air for an internal combustion engine, said apparatus comprised of:
a. At least two sequentially arranged heat exchangers for said charge air, the first supplied with ambient cooling, and the second supplied with a refrigerant;
b. A pressure containment for said heat exchangers; and
c. A water removal system for said containment.

23. The apparatus according to claim 22, additionally comprised of a thermally activated absorption refrigeration unit that is activated by waste heat from the engine, and supplies said refrigerant.

24. The apparatus according to claim 22, additionally comprised of an exhaust gas recirculation path, a cooler for the exhaust heat that transfers heat to a thermally activated absorption refrigeration cycle, which in turn supplies said refrigerant.

25. The apparatus according to claim 22, additionally comprised of a means to chill the inlet air to the charge air compressor, plus modifications to increase the compression ratio and to implement Miller cycle timing.
